(19) United States
(12) Patent Application Publication
(10) Pub. No.: US 2011/0318579 A1
(43) Pub. Date: Dec. 29, 2011

(54) Pressure-Sensitive Adhesive Transfer Tape with Differentiated Adhesion on Either Side and Method for Producing the Tape

(75) Inventors: Marc Husemann, Hamburg (DE); Daniel Klier, Reinbek (DE); Bernd Luhmann, Norderstedt (DE)

(73) Assignee: tesa SE, Hamburg (DE)

(21) Appl. No.: 13/148,017

(22) PCT Filed: Jan. 22, 2010
(86) PCT No.: PCT/EP2010/050707

§ 371 Date: Sep. 13, 2011

(30) Foreign Application Priority Data
Feb. 5, 2009 (DE) 102009007589.5

(51) Int. Cl. B32B 27/30; C08J 7/04; C08J 7/18

(52) U.S. Cl. 428/355 AC; 427/516; 427/505

(57) ABSTRACT

The present invention relates to a pressure-sensitive adhesive transfer tape, taking the form of a carrierless adhesive tape with an adhesive layer comprising a pressure-sensitive adhesive based on a poly(meth)acrylate copolymer with the following monomers: a1) acrylic acid and/or acrylic esters of the following formula: CH₂═C(R¹)(COOR²), where R¹=H or CH₃ and R² is an alkyl chain with 1-30 C atoms, a2) olefinically unsaturated monomers with functional groups, with monomers of group a1) being present to an extent of at least 50% by weight, based on the total component (a), and with monomers of group a2) being present at 0%-30% by weight, based on the total component (a), and b) a photoinitiator with a fraction of 0%-5% by weight, based on the overall polymer mixture, the pressure-sensitive adhesive being crosslinked to differing extents on its top and bottom faces by actinic radiation, the crosslinking of the pressure-sensitive adhesive being such that on both its top face and its bottom face it has a PSTC-1 adhesion of at least 1 N/cm and a difference between the adhesion on the top face and on the bottom face of at least 30%, preferably of at least 50%, based on the lower of the two adhesions.

The invention relates to a pressure-sensitive adhesive transfer tape for bonding optical components and also to a method for producing a pressure-sensitive adhesive tape.

Pressure-sensitive adhesives (PSAs) are nowadays used very diversely. In the industrial sector, accordingly, there exist a very wide variety of applications. Adhesive tapes based on PSAs are used particularly numerously in the electronics segment or in the consumer electronics segment. On account of the high numbers of units, pressure-sensitive adhesive tapes can be processed here very quickly and easily. In contrast, other operations, such as riveting or welding, for example, would be too costly and inconvenient. In addition to the usual joining function, these pressure-sensitive adhesive tapes may also have to take on further functions. Examples might include a thermal conductivity, an electrical conductivity or else an optical function. In the latter case, for example, pressure-sensitive adhesive tapes are used which fulfill light-absorbing functions, in order to prevent the entry or exit of light at unwanted sites, or light-reflecting functions, for the guiding/distribution of light. An example of another optical function is the provision of a suitable light transmission. Here pressure-sensitive adhesive tapes and PSAs are used which are highly transparent, in order to join optical components to one another and, for example, to exclude air. This has the advantage of lessening the reflection produced by the transition from air to, for example, a glass optical medium. Moreover, of course, the PSA also possesses a retaining function. Fields of application for PSAs of this kind include, for example, the bonding of touch panels on an LCD or OLED display, or the bonding of ITO (indium tin oxide) films for capacitive touch panels.

In the electronics segment in particular, PSAs are employed in the form of what are called pressure-sensitive adhesive transfer tapes, these being adhesive tapes without permanent carriers. Permanent carriers are carriers which are present in the adhesive tape even after bonding has taken place. Conversely, temporary carriers (also referred to as liner or release) are removed during or immediately after bonding, from the adhesive tape itself. If an adhesive tape is referred to below as being “backingless”, what this means, always, is that this adhesive tape does not have a permanent carrier.

High-transparency PSAs for optical use are known per se. It is preferred, accordingly, to use acrylate PSAs, since they have a high transparency, are resistant to aging and weathering, and also do not become hazy as a result of subsequent crystallization. As well as the function of high transparency, however, optical PSAs are also required to fulfill additional functions. Examples thereof are described in US 2004/0191509 A 1 and also in US 2003/0232192 A1, for example. Here, touch panels are bonded directly to displays, in order to reduce the installation height in cell phones, for example, and to increase the transmission of the image through the touch panel. The bond, however, is associated with problems, since even the slightest inclusions of air bubbles here have an adverse effect on the representation of the image. Accordingly, PSAs with different bond strengths are employed. This is achieved either by coating two different PSAs with different bond strengths onto a carrier, or coating two different PSAs directly atop one another. Both methods are relatively costly and inconvenient, and complex.

From practice, furthermore, increasing numbers of applications are known for pressure-sensitive adhesive tapes with differentiated PSAs, since at the end of the lifecycle of an electronic device, for example, the individual components must be taken apart, and this operation is facilitated if at least one PSA side can be removed more easily.

From the prior art (DE 43 16 317 C2, DE 101 63 545 A1) it is known to combine different adhesion properties on top face and bottom face in an adhesive layer, by setting a crosslinking gradient within the adhesive layer instead of uniformly crosslinking the adhesive.

It was an object of the present invention to specify a pressure-sensitive adhesive tape which meets the special requirements for the bonding of optical components and which, moreover, is redetachable in a simplified way. The adhesive tape ought furthermore to be easily producible.

The present invention solves the problem by means of an adhesive transfer tape according to claim 1. A co-independent solution is provided by a method according to claim 5. Preferred embodiments and developments are subject matter of the respective dependent claims.

The particular requirements imposed on adhesive tapes for optical applications are met only by specific PSAs. One particular challenge in this context is the permanent adhesive bonding by means of a high-transparency PSA. In order to meet this requirement, but possibly also to allow redetachment, a suitable high-transparency PSA ought to have different bond strengths on the top and bottom faces. This generally necessitates a high level of cost and complexity in production, by multiple coating of a carrier and/or by lamination of different PSAs to one another.

It has emerged that specific PSAs are suitable for optical applications and also, through appropriate irradiation, have different bond strengths on top and bottom faces. Accordingly, a pressure-sensitive adhesive transfer tape, in other words a backingless pressure-sensitive adhesive tape with different bond strengths on top and bottom faces, can be produced by coating a temporary carrier with the PSA and subsequently irradiating the system.

A PSA based on poly(meth)acrylate copolymer has emerged as a suitable PSA for the pressure-sensitive adhesive transfer tape. The polyacrylate-containing PSA is based on a pressure-sensitively adhesive poly(meth)acrylate copolymer with the following monomers:
a1) acrylic acid and/or acrylic esters of the following formula:

CH₂═C(R¹)(COOR²),
where R¹ is H or CH₃ and R² is an alkyl chain having 1-30 C atoms,
a2) olefinically unsaturated monomers having functional groups.

The monomers of group a1) are present at not less than 50% by weight, based on total component (a), consisting of a1) and a2), and the monomers of group a2) are present at 0%-30% by weight, based on the total component (a). Furthermore, the PSA comprises a photoinitiator b), more particularly a UV photoinitiator, with a fraction of 0%-5% by weight, based on the total polymer mixture. The fraction of the photoinitiator here is guided in particular by the nature of the irradiation; where electron-beam crosslinking is envisaged, there is usually no photoinitiator present (the fraction is 0%); in the case of UV crosslinking, more particularly by means of UV-A radiation, the fraction is typically greater than 0%. Optionally, moreover, the PSA may also comprise further components.

Through actinic irradiation, i.e., irradiation which initiates crosslinking, typically by means of UV light or electron irradiation, a crosslinking gradient is generated within the PSA layer—the irradiated side becomes highly crosslinked and therefore has a lower bond strength than the less highly crosslinked side remote from the radiation. In this way, in particular, a bond strength difference between top face and bottom face of the layer of adhesive is achieved of at least 30%, preferably of at least 50%, based on the lower bond strength—in other words, the side with the higher bond strength has at least 130% of the bond strength of the side with the lower bond strength. In order to achieve sufficient joining of the components that are to be bonded, a bond strength of not less than 1 N/cm on both sides of the pressure-sensitive adhesive layer is necessary, and is achieved in the case of appropriate crosslinking. The depth of penetration of the radiation into the layer of adhesive, and hence the crosslinking at the depth in question, is dependent on the nature and intensity of the radiation, but also on the PSA and possible components additionally present therein. Fine-tuning must therefore be performed in each individual case. Examples for suitable crosslinking are given below.

In particular, the above-described PSA may fulfill the properties required for optical applications. Achieved is a light transmittance of at least 80%, preferably of at least 85%, and a haze of not more than 5%, preferably of not more than 2.5% (measured in each case in accordance with ASTM D 1003).

In a preferred embodiment, the PSA comprises as crosslinker a di- or polyfunctional crosslinker or a mixture of such crosslinkers. The weight fraction of the crosslinkers is preferably up to 5% by weight, based on the total polymer mixture.

As crosslinkers it is possible here to use all di- or polyfunctional compounds whose functional groups are able to enter into a linking reaction with the free radicals formed. These reactions are preferably carried out at a double bond. Hence, for example, di- and poly-functional vinyl compounds are among those suitable as crosslinker substances.

A co-independent solution to the problem described above is provided by a method for producing an adhesive tape, as claimed in claim 5. An adhesive tape of this kind is more particularly an adhesive transfer tape, though the method is also suitable for adhesive tapes with a permanent carrier. For producing the adhesive tape, a temporary or permanent carrier is first of all coated with a PSA. The PSA is one based on a poly(meth)acrylate copolymer as described above. The pressure-sensitive adhesive layer thus formed is then irradiated with actinic radiation from one side, preferably from the side not covered by the carrier. The dose in this case is selected such that the intensity of radiation decreases with the depth of penetration of the radiation into the pressure-sensitive adhesive layer, and so, on the side facing the radiation, a high level of crosslinking is achieved, and a lower level of crosslinking, or none at all, is achieved on the remote side. By tailoring the crosslinking, the bond strengths are adjusted in such a way that the PSTC-1 bond strength of the side facing the radiation differs from the bond strength of the side remote from the radiation by at least 30%, based on the lower of the two levels.

### Pressure-Sensitive Adhesive:

In the design and configuration of optical components, such as glass windows or films for the protection of displays, for example, it is necessary to give consideration to the interaction of the materials used with the nature of the irradiated light. In one derived version, the law of conservation of energy takes on the following form:

T(λ)+p(λ)+a(λ)=1,

where T(λ) describes the fraction of light transmitted, p(λ) the fraction of light reflected, and a(λ) the fraction of light absorbed (λ: wavelength), and where the overall intensity of the irradiated light is standardized to 1. Depending on the application of the optical component, it is appropriate to optimize individual terms out of these three, and to suppress the others. Optical components designed for transmission are to be distinguished by values of close to 1 for T(λ). This is achieved by reducing the amount of p(λ) and a(λ). Acrylate copolymer-based PSAs normally have no significant absorption in the visible range, i.e., in the wavelength range between 400 nm and 700 nm. This can be easily verified by measurements with a UV-Vis spectrophotometer. Critical interest therefore attaches to p(λ). Reflection is an interface phenomenon which is dependent on the refractive indices n_{d,i} of two phases i that are in contact, and is described by the Fresnel equation:

$$p ( λ ) = {( \frac{{n}_{d , 2} - {n}_{d , 1}}{{n}_{d , 2} + {n}_{d , 1}} )}^{2}$$

For the case of isorefractive materials, for which n_{d,2}=n_{d,1}, p(λ) becomes 0. This explains the need to adapt the refractive index of a PSA for use for optical components to that of the materials that are to be bonded. Typical values for various such materials are set out in table 1.

TABLE 1

| Material | Refractive index n_{d} |
|---|---|
| Quartz glass | 1.458 |
| Borosilicate crown (BK7) | 1.514 |
| Borosilicate crown | 1.518 |
| Flint | 1.620 |

(Source: Pedrotti, Pedrotti, Bausch, Schmidt, Optik, 1996, Prentice-Hall, Munich. Data at X = 588 nm)

As has already been described, PSAs used are (meth)acrylate PSAs. The (meth)acrylate PSAs, which are obtainable by radical polymerization, are composed to an extent of not less than 50% by weight of at least one acrylic monomer from the group of the compounds of the following general formula:

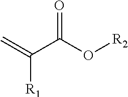

where R₁ is H or CH₃ and the radical R₂ is H or CH₃ or is selected from the group of the branched or unbranched, saturated alkyl groups having 1-30 carbon atoms.

The monomers here are preferably selected such that the resulting polymers can be employed as PSAs at room temperature or higher temperatures, more particularly such that the resulting polymers possess pressure-sensitive adhesive properties in accordance with the “Handbook of Pressure Sensitive Adhesive Technology” by Donatas Satas (van Nostrand, New York 1989).

In a preferred embodiment, more particularly for use in the bonding of optical components, the (meth)acrylate PSAs have a refractive index n_{d}>1.47 at 20° C.

The (meth)acrylate PSAs may be obtained preferably by polymerization of a monomer mixture composed of acrylic esters and/or methacrylic esters and/or the corresponding free acids, with the formula

CH₂═CH(R₁)(COOR₂),

where R₁ is H or CH₃ and R₂ is H or an alkyl chain having 1-20 C atoms.

The molar masses M_{w} of the polyacrylates used are preferably M_{w}≧200 000 g/mol.

In a further-preferred embodiment, acrylic or methacrylic monomers are used that consist of acrylic and methacrylic esters with alkyl groups of 4 to 14 C atoms, preferably 4 to 9 C atoms. Specific examples, without wishing to be restricted by this enumeration, are methyl acrylate, methyl methacrylate, ethyl acrylate, n-butyl acrylate, n-butyl methacrylate, n-pentyl acrylate, n-hexyl acrylate, n-heptyl acrylate, n-octyl acrylate, n-octyl methacrylate, n-nonyl acrylate, lauryl acrylate, stearyl acrylate, behenyl acrylate, and their branched isomers, such as, for example, isobutyl acrylate, 2-ethylhexyl acrylate, 2-ethylhexyl methacrylate isooctyl acrylate, and isooctyl methacrylate.

Further classes of compound to be used are monofunctional acrylates and/or methacrylates of bridged cycloalkyl alcohols, consisting of at least 6 C atoms. The cycloalkyl alcohols may also be substituted—for example, by C-1-6 alkyl groups, halogen atoms or cyano groups. Specific examples are cyclohexyl methacrylates, isobornyl acrylate, isobornyl methacrylates, and 3,5-dimethyladamantyl acrylate.

In a further embodiment, monomers are used which carry polar groups such as carboxyl radicals, sulfonic and phosphonic acid, hydroxy radicals, lactam and lactone, N-substituted amide, N-substituted amine, carbamate, epoxy, thiol, alkoxy, and cyano radicals, ethers or the like.

Moderate basic monomers are, for example, N,N-dialkyl-substituted amides, such as, for example, N,N-dim ethylacrylamide, N,N-dim ethylmethylmethacrylamide, N-tert-butylacrylamide, N-vinylpyrrolidone, N-vinyllactam, dimethylaminoethyl methacrylate, dimethylaminoethyl acrylate, diethylaminoethyl methacrylate, diethylaminoethyl acrylate, N-methylolmethacrylamide, N-(butoxymethyl)methacrylamide, N-methylolacrylamide, N-(ethoxymethyl)acrylamide, N-isopropylacrylamide, this enumeration not being conclusive.

Further preferred examples are hydroxyethyl acrylate, hydroxypropyl acrylate, hydroxylethyl methacrylate, hydroxypropyl methacrylate, allyl alcohol, maleic anhydride, itaconic anhydride, itaconic acid, glyceridyl methacrylate, phenoxyethyl acrylate phenoxyethyl methacrylate, 2-butoxyethyl methacrylate, 2-butoxyethyl acrylate, cyanoethyl methacrylate, cyanoethyl acrylate, glyceryl methacrylate, 6-hydroxyhexyl methacrylate, vinylacetic acid, tetrahydrofurfuryl acrylate, 8-acryloyloxypropionic acid, trichloroacrylic acid, fumaric acid, crotonic acid, aconitic acid, dimethylacrylic acid, this enumeration not being conclusive.

In another very preferred embodiment, monomers used are vinyl esters, vinyl ethers, vinyl halides, vinylidene halides, vinyl compounds with aromatic rings and heterocycles in α-position. Here as well, mention may be made nonexclusively of certain examples: vinyl acetate, vinylformamide, vinylpyridine, ethyl vinyl ether, vinyl chloride, vinylidene chloride, and acrylonitrile.

Use is made in particular, with particular preference, of comonomers which carry at least one aromatic which has an elevating effect on refractive index. Suitable components include aromatic vinyl compounds, such as styrene, for example, where preferably the aromatic rings consist of C₄ to C₁₈ units and may also contain heteroatoms. Particularly preferred examples are 4-vinylpyridine, N-vinylphthalimide, methylstyrene, 3,4-dimethoxystyrene, 4-vinylbenzoic acid, benzyl acrylate, benzyl methacrylate, phenyl acrylate, phenyl methacrylate, tert-butylphenyl acrylate, tert-butylphenyl methacrylate, 4-biphenyl acrylate and methacrylate, 2-naphthyl acrylate and methacrylate, and also mixtures of those monomers, this enumeration not being conclusive.

As described, in a preferred embodiment the comonomer composition is selected such that the refractive index is greater than 1.4700. In this case it is possible to calculate the refractive index, starting from the refractive index of the respective homopolymers, via the proportional composition in the copolymer. A listing of typical refractive indices of homopolymers and copolymers is found in Polymer Handbook, 4^{th} edition, J. Brandrup, E. H. Immergut, E. A. Grulke, John Wiley & Sons, Inc.

Furthermore, in another procedure, photoinitiators with a copolymerizable double bond are used. Suitable photoinitiators are Norrish I and II photoinitiators. Examples are, e.g., benzoin acrylate and an acrylated benzophenone from UCB (Ebecryl P 36®). In principle it is possible to copolymerize all photoinitiators that are known to the skilled person and that are able to crosslink the polymer via a free-radical mechanism under UV irradiation. An overview of possible photoinitiators that can be used and that can be functionalized with a double bond is given in Fouassier: “Photoinitiation, Photopolymerization and Photocuring: Fundamentals and Applications”, Hanser-Verlag, Munich 1995. For further details, refer to Carroy et al. in “Chemistry and Technology of UV and EB Formulation for Coatings, Inks and Paints”, Oldring (ed.), 1994, SITA, London.

The use of straight-acrylic PSAs is preferred when the drop in radiation dose with depth of penetration into the pressure-sensitive adhesive layer is to be not too great. If, however, a greater drop in radiation dose over the penetration depth is desired, the PSA ought to be admixed with additives, more particularly resins and/or UV initiators.

In addition to the constituents identified above, the PSA may be admixed with resins. As tackifying resins to be added it is possible without exception to use all tackifier resins that are already known and are described in the literature, more particularly those which possess no negative effect on the transparency of the adhesive. Mention may be made, as representatives, of the pinene resins, indene resins, and rosins, their disproportionated, hydrogenated, polymerized, and esterified derivatives and salts, the aliphatic and aromatic hydrocarbon resins, terpene resins and terpene-phenolic resins, and also C5, C9, and other hydrocarbon resins. Any desired combinations of these and further resins may be used in order to adjust the properties of the resultant adhesive in accordance with requirements. Generally speaking, it is possible to employ all resins that are compatible (soluble) with the polyacrylate in question; more particularly, reference may be made to all aliphatic, aromatic, and alkylaromatic hydrocarbon resins, hydrocarbon resins based on pure monomers, hydrogenated hydrocarbon resins, functional hydrocarbon resins, and natural resins. Reference is made expressly to the depiction of the state of knowledge in the “Handbook of Pressure Sensitive Adhesive Technology” by Donatas Satas (van Nostrand, 1989).

For the purpose of improving the transparency, it is preferred to use resins that are transparent and have very good compatibility with the polymer. Hydrogenated or partly hydrogenated resins frequently have these properties. When selecting the resins, moreover, consideration should likewise be given to their effect on the refractive index. Resins with a high hydrogenated and aliphatic fraction tend to lower the refractive index, while resins with a high aromatic fraction cause the refractive index to increase.

In addition, crosslinkers (c) and crosslinking promoters may also be admixed to the PSA. Suitable crosslinkers for electron beam crosslinking and UV crosslinking are, for example, difunctional or polyfunctional acrylates, difunctional or polyfunctional isocyanates (including those in blocked form) or difunctional or polyfunctional epoxides. Furthermore, it is also possible for thermally activatable crosslinkers to be added, such as Lewis acid, metal chelates or polyfunctional isocyanates, for example. The fraction of the crosslinkers is preferably up to 5% by weight, based on the total polymer mixture.

For optional crosslinking with UV light, the PSAs are admixed with UV-absorbing photoinitiators (b). Useful photoinitiators which can be used to very good effect are benzoin ethers, such as benzoin methyl ether and benzoin isopropyl ether, substituted acetophenones, such as 2,2-diethoxyacetaphenone (available as Irgacure 651® from Ciba Geigy®), 2,2-dimethoxy-2-phenyl-1-phenylethanonone, dimethoxyhydroxyacetophenone, substituted α-ketols, such as 2-methoxy-2-hydroxypropiophenone, aromatic sulfonyl chlorides, such as 2-naphthyl sulfonyl chloride, and photoactive oximes, such as 1-phenyl-1,2-propanedione-2-(O-ethoxycarbonyl)oxime, for example.

The abovementioned photoinitiators and others which can be used, and others of the Norrish I or Norrish II type, may contain the following radicals: benzophenone, acetophenone, benzil, benzoin, hydroxyalkylphenone, phenyl cyclohexyl ketone, anthraquinone, trimethylbenzoylphosphine oxide, methylthiophenyl morpholine ketone, aminoketone, azobenzoin, thioxanthone, hexarylbisimidazole, triazine, or fluorenone, it being possible for each of these radicals to be substituted additionally by one or more halogen atoms and/or by one or more alkyloxy groups and/or by one or more amino groups or hydroxyl groups. For a representative overview, refer to Fouassier: “Photoinitiation, Photopolymerization and Photocuring: Fundamentals and Applications”, Hanser-Verlag, Munich 1995. For further details, reference may be made to Carroy et al. in “Chemistry and Technology of UV and EB Formulation for Coatings, Inks and Paints”, Oldring (ed.), 1994, SITA, London.

### Preparation Process for the (Meth)Acrylate PSAs

For the polymerization the monomers are chosen such that the resultant polymers can be used at room temperature or higher temperatures as PSAs, particularly such that the resulting polymers possess pressure-sensitive adhesive properties in accordance with the “Handbook of Pressure Sensitive Adhesive Technology” by Donatas Satas (van Nostrand, New York 1989).

In order to achieve a polymer glass transition temperature T_{g} of ≦25° C. as preferred for PSAs it is preferred, in accordance with the comments made above, to select the monomers in such a way, and choose the quantitative composition of the monomer mixture advantageously in such a way, as to result in the desired T_{g} for the polymer in accordance with the Fox equation (E1) (cf. T. G. Fox, Bull. Am. Phys. Soc. 1 (1956) 123).

$$\frac{1}{{T}_{g}} = {\sum }_{N} \frac{{w}_{n}}{{T}_{g , n}} \qquad ( E1 )$$

In this equation, n represents the serial number of the monomers used, wₙ the mass fraction of the respective monomer n (% by weight), and T_{G,n} the respective glass transition temperature of the homopolymer of the respective monomers n, in K.

For the preparation of the poly(meth)acrylate PSAs it is advantageous to carry out conventional free-radical polymerizations. For the polymerizations which proceed free-radically it is preferred to employ initiator systems which also contain further free-radical initiators for the polymerization, especially thermally decomposing, free-radical-forming azo or peroxo initiators. In principle, however, all customary initiators which are familiar to the skilled worker for acrylates are suitable. The production of C-centered radicals is described in Houben Weyl, Methoden der Organischen Chemie, Vol. E 19a, pp. 60-147. These methods are employed, preferentially, in analogy.

Examples of free-radical sources are peroxides, hydroperoxides, and azo compounds; some nonlimiting examples of typical free-radical initiators that may be mentioned here include potassium peroxodisulfate, dibenzoyl peroxide, cumene hydroperoxide, cyclohexanone peroxide, di-t-butyl peroxide, azodiisobutyronitrile, cyclohexylsulfonyl acetyl peroxide, diisopropyl percarbonate, t-butyl peroctoate, and benzpinacol. In one very preferred embodiment the free-radical initiator used is 1,1-azobis(cyclohexanecarbonitrile) (Vazo 88™ from DuPont) or azodiisobutyronitrile (AIBN).

The average molecular weights M_{w} of the PSAs formed in the free-radical polymerization are preferably chosen such that they are situated within a range of 200 000 to 4 000 000 g/mol; in particular, PSAs are prepared which have average molecular weights M_{w} of 400 000 to 1 400 000 g/mol for the further use as hotmelt PSAs with resilience. The average molecular weight is determined by size exclusion chromatography (GPC) or matrix-assisted laser desorption/ionization mass spectrometry (MALDI-MS).

The polymerization may be conducted in bulk, in the presence of one or more organic solvents, in the presence of water, or in mixtures of organic solvents and water. The aim is to minimize the amount of solvent used. Suitable organic solvents are pure alkanes (e.g., hexane, heptane, octane, isooctane), aromatic hydrocarbons (e.g., benzene, toluene, xylene), esters (e.g., ethyl, propyl, butyl or hexyl acetate), halogenated hydrocarbons (e.g., chlorobenzene), alkanols (e.g., methanol, ethanol, ethylene glycol, ethylene glycol monomethyl ether), and ethers (e.g., diethyl ether, dibutyl ether) or mixtures thereof. A water-miscible or hydrophilic cosolvent may be added to the aqueous polymerization reactions in order to ensure that the reaction mixture is present in the form of a homogeneous phase during monomer conversion. Cosolvents which can be used with advantage for the present PSA are chosen from the following group, consisting of aliphatic alcohols, glycols, ethers, glycol ethers, pyrrolidines, N-alkylpyrrolidinones, N-alkylpyrrolidones, polyethylene glycols, polypropylene glycols, amides, carboxylic acids and salts thereof, esters, organic sulfides, sulfoxides, sulfones, alcohol derivatives, hydroxy ether derivatives, amino alcohols, ketones and the like, and also derivatives and mixtures thereof.

The polymerization time—depending on conversion and temperature—is between 2 and 72 hours. The higher the reaction temperature which can be chosen, i.e., the higher the thermal stability of the reaction mixture, the shorter can be the chosen reaction time.

As regards initiation of the polymerization, the introduction of heat is essential for the thermally decomposing initiators. For these initiators the polymerization can be initiated by heating to from 50 to 160° C., depending on initiator type.

For the preparation it can also be of advantage to polymerize the (meth)acrylate PSAs in bulk. A particularly suitable technique for use in this case is the prepolymerization technique. Polymerization is initiated with UV light but taken only to a low conversion of about 10-30%. The resulting polymer syrup can then be welded, for example, into films (in the simplest case, ice cubes) and then polymerized through to a high conversion in water. These pellets can subsequently be used as acrylate hot-melt adhesives, it being particularly preferred to use, for the melting operation, film materials which are compatible with the polyacrylate. For this preparation method as well it is possible to add the thermally conductive materials before or after the polymerization.

Another advantageous preparation process for the poly(meth)acrylate PSAs is that of anionic polymerization. In this case the reaction medium used preferably comprises inert solvents, such as aliphatic and cycloaliphatic hydrocarbons, for example, or else aromatic hydrocarbons.

The living polymer is in this case generally represented by the structure P_{L}(A)-Me, where Me is a metal from group I, such as lithium, sodium or potassium, and P_{L}(A) is a growing polymer from the acrylate monomers. The molar mass of the polymer under preparation is controlled by the ratio of initiator concentration to monomer concentration. Examples of suitable polymerization initiators include n-propyllithium, n-butyllithium, sec-butyllithium, 2-naphthyllithium, cyclohexyllithium, and octyllithium, though this enumeration makes no claim to completeness. Furthermore, initiators based on samarium complexes are known for the polymerization of acrylates (Macromolecules, 1995, 28, 7886) and can be used here.

It is also possible, furthermore, to employ difunctional initiators, such as 1,1,4,4-tetraphenyl-1,4-dilithiobutane or 1,1,4,4-tetraphenyl-1,4-dilithioisobutane, for example. Coinitiators can likewise be employed. Suitable coinitiators include lithium halides, alkali metal alkoxides, and alkylaluminum compounds. In one very preferred version the ligands and coinitiators are chosen so that acrylate monomers, such as n-butyl acrylate and 2-ethylhexyl acrylate, for example, can be polymerized directly and do not have to be generated in the polymer by transesterification with the corresponding alcohol.

Methods suitable for preparing poly(meth)acrylate PSAs with a narrow molecular weight distribution also include controlled free-radical polymerization methods. In that case it is preferred to use, for the polymerization, a control reagent of the general formula:

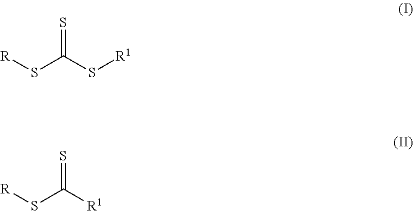

in which R and R¹ are chosen independently of one another or are identical, and represent
branched and unbranched C₁ to C₁₈ alkyl radicals; C₃ to C₁₈ alkenyl radicals; C₃ to C₁₈ alkynyl radicals;
C₁ to C₁₈ alkoxy radicals;
C₃ to C₁₈ alkynyl radicals; C₃ to C₁₈ alkenyl radicals; C₁ to C₁₈ alkyl radicals substituted by at least one OH group or a halogen atom or a silyl ether;
C₂-C₁₈ heteroalkyl radicals having at least one O atom and/or one NR* group in the carbon chain, R* being able to be any radical (particularly an organic radical);
C₃-C₁₈ alkynyl radicals, C₃-C₁₈ alkenyl radicals, C₁-C₁₈ alkyl radicals substituted by at least one ester group, amine group, carbonate group, cyano group, isocyano group and/or epoxy group and/or by sulfur;
C₃-C₁₂ cycloalkyl radicals;
C₆-C₁₈ aryl or benzyl radicals;
hydrogen.

Control reagents of type (I) are preferably composed of the following further-restricted compounds:

halogen atoms therein are preferably F, Cl, Br or I, more preferably Cl and Br.

Outstandingly suitable alkyl, alkenyl, and alkynyl radicals in the various substituents include both linear and branched chains.

Examples of alkyl radicals containing 1 to 18 carbon atoms are methyl, ethyl, propyl, isopropyl, butyl, isobutyl, t-butyl, pentyl, 2-pentyl, hexyl, heptyl, octyl, 2-ethylhexyl, t-octyl, nonyl, decyl, undecyl, tridecyl, tetradecyl, hexadecyl, and octadecyl.

Examples of alkenyl radicals having 3 to 18 carbon atoms are propenyl, 2-butenyl, 3-butenyl, isobutenyl, n-2,4-pentadienyl, 3-methyl-2-butenyl, n-2-octenyl, n-2-dodecenyl, isododecenyl, and oleyl.

Examples of alkynyl having 3 to 18 carbon atoms are propynyl, 2-butynyl, 3-butynyl, n-2-octynyl, and n-2-octadecynyl.

Examples of hydroxy-substituted alkyl radicals are hydroxypropyl, hydroxybutyl, and hydroxyhexyl.

Examples of halogen-substituted alkyl radicals are dichlorobutyl, monobromobutyl, and trichlorohexyl.

An example of a suitable C₂-C₁₈ heteroalkyl radical having at least one O atom in the carbon chain is —CH₂—CH₂—O—CH₂—CH₃.

Examples of C₃-C₁₂ cycloalkyl radicals include cyclopropyl, cyclopentyl, cyclohexyl, and trimethylcyclohexyl.

Examples of C₆-C₁₈ aryl radicals include phenyl, naphthyl, benzyl, 4-tert-butylbenzyl, and other substituted phenyls, such as ethyl, toluene, xylene, mesitylene, isopropylbenzene, dichlorobenzene or bromotoluene.

The above enumerations serve only as examples of the respective groups of compounds, and make no claim to completeness.

Other compounds which can also be used as control reagents include those of the following types:

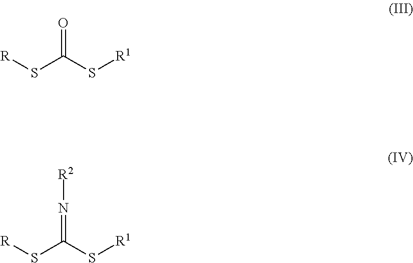

where R², again independently from R and R¹, may be selected from the group recited above for these radicals.

In the case of the conventional ‘RAFT’ process, polymerization is generally carried out only up to low conversions (WO 98/01478 A1) in order to produce very narrow molecular weight distributions. As a result of the low conversions, however, these polymers cannot be used as PSAs and in particular not as hotmelt PSAs, since the high fraction of residual monomers adversely affects the technical adhesive properties; the residual monomers contaminate the solvent recyclate in the concentration operation; and the corresponding self-adhesive tapes would exhibit very high outgassing behavior. In order to circumvent this disadvantage of low conversions, the polymerization in one particularly preferred procedure is initiated two or more times.

As a further controlled free-radical polymerization method it is possible to carry out nitroxide-controlled polymerizations. For free-radical stabilization, in a favorable procedure, use is made of nitroxides of type (Va) or (Vb):

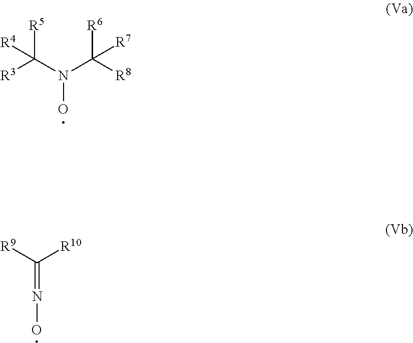

where R³, R⁴, R⁵, R⁶, R⁷, R⁸, R⁹, and R¹⁹ independently of one another denote the following compounds or atoms:
i) halides, such as chlorine, bromine or iodine, for example,
ii) linear, branched, cyclic, and heterocyclic hydrocarbons having 1 to 20 carbon atoms, which may be saturated, unsaturated or aromatic,
iii) esters —COOR¹¹, alkoxides —OR¹² and/or phosphonates —PO(OR¹³)₂,
   where R¹¹, R¹² or R¹³ stand for radicals from group ii).

Compounds of the type (Va) or (Vb) can also be attached to polymer chains of any kind (primarily such that at least one of the abovementioned radicals constitutes a polymer chain of this kind) and may therefore be used for the synthesis of polyacrylate PSAs. Further preferred are controlled regulators for the polymerization of compounds of the type:
2,2,5,5-tetramethyl-1-pyrrolidinyloxyl (PROXYL), 3-carbamoyl-PROXYL, 2,2-dimethyl-4,5-cyclohexyl-PROXYL, 3-oxo-PROXYL, 3-hydroxylimine-PROXYL, 3-aminomethyl-PROXYL, 3-methoxy-PROXYL, 3-t-butyl-PROXYL, 3,4-di-t-butyl-PROXYL
2,2,6,6-tetramethyl-1-piperidinyloxyl pyrrolidinyloxyl (TEMPO), 4-benzoyloxy-TEMPO, 4-methoxy-TEMPO, 4-chloro-TEMPO, 4-hydroxy-TEMPO, 4-oxo-TEMPO, 4-amino-TEMPO, 2,2,6,6-tetraethyl-1-piperidinyloxyl, 2,2,6-trimethyl-6-ethyl-1-piperidinyloxyl
N-tert-butyl 1-phenyl-2-methylpropyl nitroxide
N-tert-butyl 1-(2-naphthyl)-2-methylpropyl nitroxide
N-tert-butyl 1-diethylphosphono-2,2-dimethylpropyl nitroxide
N-tert-butyl 1-dibenzylphosphono-2,2-dimethylpropyl nitroxide
N-(1-phenyl-2-methylpropyl) 1-diethylphosphono-1-methylethyl nitroxide
di-t-butyl nitroxide
diphenyl nitroxide
t-butyl t-amyl nitroxide.

A series of further polymerization methods, in accordance with which the PSAs can be prepared by an alternative procedure can be chosen from the prior art: U.S. Pat. No. 4,581,429 A discloses a controlled-growth free-radical polymerization process which uses as its initiator a compound of the formula R′R″N—O—Y, in which Y is a free-radical species which is able to polymerize unsaturated monomers. In general, however, the reactions have low conversion rates. A particular problem is the polymerization of acrylates, which takes place only with very low yields and molar masses. WO 98/13392 A1 describes open-chain alkoxyamine compounds which have a symmetrical substitution pattern. EP 735 052 A1 discloses a process for preparing thermoplastic elastomers having narrow molar mass distributions. WO 96/24620 A1 describes a polymerization process in which very specific free-radical compounds, such as phosphorus-containing nitroxides based on imidazolidine, for example, are employed. WO 98/44008 A1 discloses specific nitroxyls based on morpholines, piperazinones, and piperazinediones. DE 199 49 352 A1 describes heterocyclic alkoxyamines as regulators in controlled-growth free-radical polymerizations. Corresponding further developments of the alkoxyamines or of the corresponding free nitroxides improve the efficiency for the preparation of polyacrylates.

As a further controlled polymerization method, atom transfer radical polymerization (ATRP) can be used advantageously to synthesize the polyacrylate PSAs, in which case use is made preferably as initiator of monofunctional or difunctional secondary or tertiary halides and, for abstracting the halide(s), of complexes of Cu, Ni, Fe, Pd, Pt, Ru, Os, Rh, Co, Ir, Ag or Au (EP 0 824 111 A1; EP 826 698 A1; EP 824 110 A1; EP 841 346 A1; EP 850 957 A1). The various possibilities of ATRP are further described in the specifications U.S. Pat. No. 5,945,491 A, U.S. Pat. No. 5,854,364 A, and U.S. Pat. No. 5,789,487 A.

### Temporary Carrier

The PSA is preferably laminated or coated on a release liner as a temporary carrier for the PSA. Particularly suitable release papers include glassine, HDPE or LDPE liners, which in one preferred version have siliconization as a release ply. In one very preferred version of the invention, a release liner film is used. In one very preferred version, the release liner film ought to have siliconization as a release means. Furthermore, the release liner film ought to have an extremely smooth surface and also, for the case of UV crosslinking, a very low absorption for UV light. It is preferred to use PET films that are free from antiblocking agent, in combination of silicone systems coated from solution.

Where permanent carriers are used, films suitable as carrier film and stabilizing film are more particularly those which likewise possess a high refractive index n_{d} of greater than 1.43 at 20° C.

### Coating Process, Preparation of the Film of PSA

For production, in one preferred version, the PSA is coated from solution onto the temporary carrier.

If desired, coating may also take place onto a carrier film. As a carrier film it is possible for example to use filmic films, such as PET, PEN, polyimide, PP, PE or PVC, for example, nonwoven fabrics, woven fabrics, and all of the carrier materials known to the skilled person for double-sided adhesive tapes.

For the pretreatment of the carrier materials it is possible, for example, to carry out corona or plasma pretreatment; from the melt or from solution, a primer may be applied; or chemical etching may be performed.

For the coating of the PSA from solution, the solvent is removed by supply of heat, for example, in a drying tunnel.

The above-described polymers may also, furthermore, be coated as hotmelt systems (i.e., from the melt). For the production process it may therefore be necessary to remove the solvent from the PSA. In this case it is possible in principle to use any of the techniques known to the skilled person. One very preferred technique is that of concentration using a single-screw or twin-screw extruder. The twin-screw extruder may be operated corotatingly or counterrotatingly. The solvent or water is preferably distilled off over two or more vacuum stages. Counterheating is also carried out, depending on the distillation temperature of the solvent. The residual solvent fractions amount to preferably <1%, more preferably <0.5%, and very preferably <0.2%. Further processing of the hotmelt takes place from the melt.

For coating as a hotmelt, it is possible to employ different coating processes. In one embodiment, the PSAs are coated by a roll coating process. Different roll coating processes are described in the “Handbook of Pressure Sensitive Adhesive Technology” by Donatas Satas (van Nostrand, New York 1989). In another embodiment, coating takes place via a melt die. In a further preferred process, coating is carried out by extrusion. Extrusion coating is performed preferably using an extrusion die. The extrusion dies used may come advantageously from one of the three following categories: T-dies, fishtail dies, and coathanger dies. The individual types differ in the design of their flow channel. Through the coating it is also possible for the PSAs to undergo orientation.

Independently of the coating process, the PSA is applied, in a preferred embodiment, at between 25 and 250 g/m², more preferably between 50 and 150 g/m².

### Electron Beam Curing

For producing the crosslinking profile and for setting the different bond strengths, curing in one embodiment takes place using electron beams. Where this mode of crosslinking is intended, there is no absolute need for a photoinitiator in the adhesive. The fraction of the photoinitiator in this case, therefore, is preferably 0%.

Typical irradiation equipment which can be employed includes linear cathode systems, scanner systems, and segmented cathode systems, where electron beam accelerators are used. A comprehensive description of the state of the art and the most important process parameters are found in Skelhorne, Electron Beam Processing, in Chemistry and Technology of UV and EB formulation for Coatings, Inks and Paints, Vol. 1, 1991, SITA, London.

For implementing the desired properties of the PSA it is necessary to select the acceleration voltage and the scatter dose as a function of the thickness of the pressure-sensitive adhesive layer. Generally speaking, the PSA layer may be differentiated into a number of thickness ranges (coatweights): 25-50 g/m², 51-100 g/m², 101 to 175 g/m², and 176-250 g/m².

For PSAs with a coatweight of 25-50 g/m² it is preferred to use acceleration voltages of 20-40 kV and scatter doses of 20 to 80 kGy.

For PSAs with a coatweight of 51-100 g/m² it is preferred to use acceleration voltages of 40-80 kV and scatter doses of 40 to 100 kGy.

For PSAs with a coatweight of 101-175 g/m² it is preferred to use acceleration voltages of 60-100 kV and scatter doses of 40 to 100 kGy.

For PSAs with a coatweight of 176-250 g/m² it is preferred to use acceleration voltages of 80-140 kV and scatter doses of 40 to 100 kGy.

The stated doses apply for an ambient temperature of 23° C. and for irradiation under an N₂ atmosphere. Irradiation takes place within a speed window of between 5 and 40 m/min.

### UV Irradiation

For UV crosslinking, irradiation takes place using shortwave ultraviolet in a wavelength range from 100 to 400 nm (UV-A: 315-380 nm; UV-B: 280-315 nm; UV-C: 100-280 nm). For suitable implementation, the composition of the PSA has a decisive influence on the crosslinking behavior. Generally speaking, if a UV photoinitiator is used as a comonomer or as an additive, irradiation takes place preferably at the wavelength at which the photoinitiator reacts most efficiently. It may also be of advantage, however, to carry out irradiation with differing wavelengths, in order to obtain a more strongly pronounced crosslinking profile.

UV irradiation takes place preferably using high-pressure or medium-pressure mercury lamps, which may have an output of 80 to 400 W/cm.

Depending on the nature of the irradiation, it is not absolutely necessary for the PSA to include a photoinitiator. The fraction of the photoinitiator may therefore in particular also be 0%. For PSAs which contain no photoinitiator, it is particularly preferred to carry out irradiation with UV-C light, more particularly in the range from about 220-280 nm, which has a UV-C dose of at least 150 mJ/cm². The dose has been measured using a UV dosimeter from Eltosch.

In the same way as for the electron beam curing, the dose required may again be dependent on the coatweight. It is generally the case that, as the dose goes up, a higher level of differentiation can be achieved between the side of the pressure-sensitive adhesive layer that is facing the UV source, and the remote side. The side facing the UV source loses tack increasingly as the UV dose goes up, and the differentiation between the two PSA sides becomes increasingly pronounced. This procedure is particularly advantageous, since it allows very high levels of differentiation to be achieved, and there is no addition of UV photoinitiator, which could adversely affect the aging behavior of the PSA in relation to transmittance or haze over a prolonged period of time.

Very good results are achieved with a UV-C dose of greater than 250 mJ/cm². The UV-C dose ought not, however, to exceed a dose of 500 mJ/cm², since otherwise film hardening is too great and the PSA loses adhesion completely.

For resin-containing PSAs, however, it may be necessary to carry out crosslinking with relatively high UV doses, since resins with aromatics fractions, in particular, may absorb UV light and they therefore reduce the crosslinking tendency.

For UV crosslinking it is possible, generally, to differentiate between 3 coatweight classes.

For PSAs without a UV photoinitiator and at up to 75 g/m², it is preferred to use a UV-C dose of not more than 400 mJ/cm² and not less than 250 mJ/cm².

For PSAs without a UV photoinitiator and from 76 g/m² up to 150 g/m², it is preferred to use a UV-C dose of not more than 450 mJ/cm² and not less than 300 mJ/cm².

For PSAs without a UV photoinitiator and from 151 g/m² up to 250 g/m², it is preferred to use a UV-C dose of not more than 500 mJ/cm² and not less than 350 mJ/cm².

For all variants, it is additionally possible, if desired, to use UV-A or UV-B radiation, in order to achieve additional crosslinking in deeper layers.

If UV photoinitiators have been added to the PSA, on the other hand, the crosslinking dose can be reduced. This applies not only to UV-C radiation but also to the UV-B and UV-A radiation. In particular, irradiation substantially by means of UV-A radiation is another possibility. The intensity of irradiation is dependent in general on the quantities and on the quantum yield of the photoinitiator employed.

The dose can be varied via the output of the UV emitter or else by the irradiation time, which is in turn controlled by the belt speed. The belt speed for UV crosslinking is preferably between 1 and 50 m/min, depending on the intensity of irradiation of the UV emitter. For UV crosslinking it may be appropriate to adapt the output of the emitter to the belt speed with which the laminated material is passed through the radiation zone.

In order to force the crosslinking reaction of the UV-crosslinked adhesive, it is preferred to carry out irradiation with hard UV-C radiation in a wavelength range less than 300 nm. The primary use of hard UV-C radiation results in a high crosslinking yield on the PSA surface. Deeper PSA layers are less highly crosslinked through irradiation with a short wavelength. In the UV irradiation for the inventive method, nevertheless, there may also be fractions of UV-A and UV-B radiation present, as well as the UV-C radiation. An additional possibility is to carry out irradiation in the absence of atmospheric oxygen. For this purpose, the pressure-sensitive adhesive layer may be masked prior to UV irradiation, or the irradiation channel is flooded with an inert gas, such as nitrogen, for example.

For PSAs without UV photoinitiators it is particularly preferred to use UV emitters which operate with at least 50%, very preferably with 70%, of their emission in a wavelength range of less than 300 nm, more preferably between 250 and 300 nm, i.e., in the UV-C range. UV radiation equipment of this kind is provided, for example, by the companies Eltosch, Fusion, and IST. A further possibility is to use a doped glass in order to filter out the radiation range greater than 300 nm.

For PSAs with UV photoinitiator, it is preferred to irradiate in the softer UV-A or UV-B dose range, especially for PSA coatweights of greater than 76 g/m². In order to irradiate more in the UV-A or UV-B wavelength range, it may be necessary to filter out the hard UV-C radiation in a wavelength range of less than 250 nm. The primary use of softer UV-A and UV-B radiation results in a higher crosslinking yield under gentle conditions, and in this case the differentiation of the PSA sides may be achieved through the drop in dose in the PSA, and therefore can likewise be controlled by the layer thickness. In addition, the PSA to be crosslinked may be masked with a siliconized film which absorbs the hard wavelength range. This measure at the same time excludes the influence of atmospheric oxygen. An alternative would be to use UV emitters for which at least 90% of their emission lies in the UV-A range, i.e., in a wavelength range from 300 to 400 nm. UV irradiation equipment of this kind includes, for example, the “F15T8-BLB” lamps from Sylvana or the “Sunlamp Performance 40W-R” from Philips. The fraction of the wavelength range from 250 to 320 nm is therefore minimized. Furthermore, doped glass can be used to filter out this wavelength range.

For PSAs furnished with UV photoinitiator, it is possible in general to classify coatweights from 25 to 75 g/m², for 76 to 150 g/m², and for 151 to 250 g/m².

For PSAs with UV photoinitiator and at up to 75 g/m², it is preferred to use a UV-C dose of not more than 150 mJ/cm² and not less than 0 mJ/cm² and a UV-B dose of not more than 400 mJ/cm² and not less than 100 mJ/cm².

For PSAs with UV photoinitiator and at from 76 g/m² up to 150 g/m², it is preferred to use a UV-C dose of not more than 250 mJ/cm² and not less than 0 mJ/cm² and a UV-B dose of not more than 1000 mJ/cm² and not less than 400 mJ/cm².

For PSAs with UV photoinitiator and at from 151 g/m² up to 250 g/m², it is preferred to use a UV-C dose of not more than 350 mJ/cm² and not less than 100 mJ/cm² and a UV-B dose of not more than 1500 mJ/cm² and not less than 1000 mJ/cm².

Furthermore, the UV-irradiated PSA may optionally be heated additionally for a short time. The heat may be introduced during UV irradiation and UV crosslinking, or through irradiation with, for example, additional UV radiation or IR or microwave radiation. The irradiation facilities are advantageously coupled with a suction removal apparatus. The PSA is preferably heated by IR irradiation in the wavenumber range around 1700 cm⁻¹, the temperature of the PSA being at least 100° C., preferably 120° C. or more, although an upper limit of 170° C. ought not to be exceeded. As a result of this, the crosslinking reaction is again promoted, and the PSA undergoes further loss of bond strength at the UV-irradiated points.

### Test Methods

### A. Transmittance+Haze

The transmittance and haze were determined in accordance with ASTM D1003. The system measured was an assembly of optically transparent adhesive tape and glass plate.

### B. Bond Strength

The peel strength (bond strength) was tested in accordance with PSTC-1. The adhesive tape is applied to a glass plate. A strip of the adhesive tape, 2 cm wide, is adhered by being rolled over back and forth three times using a 2 kg roller. The plate is clamped in and the self-adhesive strip is pulled by its free end in a tensile testing machine at a peel angle of 180° and at a speed of 300 nm/min. The force is reported in N/cm. In each case, both PSA sides are tested.

### UV Irradiation

For the UV irradiation, a UV unit from Eltosch was used. The unit is equipped with a medium-pressure Hg UV lamp with an intensity of 120 W/cm. The swatch specimens were each run through the unit at a speed of 20 m/min, with the specimens being irradiated in a plurality of passes in order to increase the irradiation dose. The UV dose was measured using the Power-Puck from Eltosch. The dose of one irradiation pass was approximately 140 mJ/cm² in the UV-B range and 25 mJ/cm² in the UV-C range. In order to reduce the UV-C range, it is additionally possible to use a doped glass.

### EBC Irradiation

For irradiation with electrons, crosslinking took place with a device from Electron Crosslinking AB, Halmstad, Sweden. Here, the coated pressure-sensitive adhesive tape was guided beneath the Lenard window of the accelerator via a cooling roll, which is present as standard. In the irradiation zone, the atmospheric oxygen was displaced by flushing with pure nitrogen. The belt speed was 10 m/min in each case. Irradiation voltage and scatter doses were varied.

### Preparation of Polymer 1 (Straight Acrylate):

For the polymerization, monomers were used which had been cleaned to remove stabilizers. A 2 L glass reactor conventional for free-radical polymerizations was charged with 32 g of acrylic acid, 168 g of n-butyl acrylate, 200 g of 2-ethylhexyl acrylate, and 300 g of acetone/isopropanol (97:3). After nitrogen gas had been passed through the reactor for 45 minutes with stirring, the reactor was heated to 58° C. and 0.2 g of Vazo67® (2,2′-azodi(methylbutyronitrile), from DuPont) was added. The external heating bath was then heated to 75° C., and the reaction was carried out constantly at this external temperature. After a reaction time of 1 hour, a further 0.2 g of Vazo67® (2,2′-azodi(methylbutyronitrile), from DuPont) was added. After 3 hours and 6 hours, dilution took place with 150 g of acetone/isopropanol mixture each time. For the reduction of the residual initiators, after 8 hours and 10 hours, 0.4 g of Perkadox 16® (di(4-tert-butylcyclohexyl)peroxydicarbonate, from Akzo Nobel) was added each time. After a reaction time of 22 hours, the reaction was discontinued and the batch was cooled to room temperature.

### Preparation of Polymer 2 (Resin-Modified Polyacrylate):

For the polymerization, monomers were used which had been cleaned to remove stabilizers. A 2 L glass reactor conventional for free-radical polymerizations was charged with 50 g of acrylic acid, 175 g of n-butyl acrylate, 175 g of 2-ethylhexyl acrylate, and 300 g of acetone/isopropanol (97:3). After nitrogen gas had been passed through the reactor for 45 minutes with stirring, the reactor was heated to 58° C. and 0.2 g of Vazo67® (2,2′-azodi(methylbutyronitrile), from DuPont) was added. The external heating bath was then heated to 75° C., and the reaction was carried out constantly at this external temperature. After a reaction time of 1 hour, a further 0.2 g of Vazo67® (2,2′-azodi(methylbutyronitrile), from DuPont) was added. After 3 hours and 6 hours, dilution took place with 150 g of acetone/isopropanol mixture each time. For the reduction of the residual initiators, after 8 hours and 10 hours, 0.4 g of Perkadox 16® (di(4-tert-butylcyclohexyl)peroxydicarbonate, from Akzo Nobel) was added each time. After a reaction time of 22 hours, the reaction was discontinued and the batch was cooled to room temperature. Subsequently, 25% by weight (based on the polymer) of a styrene resin (FTR 6100 from Mitsui Petrochemical Industries) and 2% by weight of Genomer 4212® (polyurethane diacrylate from Rahn) were added, and a solids content of 30% was set using acetone. The solution was clear and transparent.

Preparation of Polymer 3 (Straight Acrylate with UV Photoinitiator):

For the polymerization, monomers were used which had been cleaned to remove stabilizers. A 2 L glass reactor conventional for free-radical polymerizations was charged with 32 g of acrylic acid, 168 g of n-butyl acrylate, 200 g of 2-ethylhexyl acrylate, and 300 g of acetone/isopropanol (97:3). After nitrogen gas had been passed through the reactor for 45 minutes with stirring, the reactor was heated to 58° C. and 0.2 g of Vazo67® (2,2′-azodi(methylbutyronitrile), from DuPont) was added. The external heating bath was then heated to 75° C., and the reaction was carried out constantly at this external temperature. After a reaction time of 1 hour, a further 0.2 g of Vazo67® (2,2′-azodi(methylbutyronitrile), from DuPont) was added. After 3 hours and 6 hours, dilution took place with 150 g of acetone/isopropanol mixture each time. For the reduction of the residual initiators, after 8 hours and 10 hours, 0.4 g of Perkadox 16® (di(4-tert-butylcyclohexyl)peroxydicarbonate, from Akzo Nobel) was added each time. After a reaction time of 22 hours, the reaction was discontinued and the batch was cooled to room temperature. Subsequently, 0.5% by weight of Esacure KIP 150™ (from Lambert') was added, and a solids content of 30% was set using acetone. The solution was clear and transparent.

UV photoinitiator Esacure™ KIP 150: α-hydroxy ketone oligo[2-hydroxy-2-methyl-1-[4-(1-methylvinyl)phenyl]propanone]

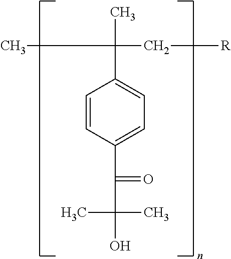

Preparation of Polymer 4 (Resin-Modified Polyacrylate with UV Photoinitiator):

For the polymerization, monomers were used which had been cleaned to remove stabilizers. A 2 L glass reactor conventional for free-radical polymerizations was charged with 50 g of acrylic acid, 175 g of n-butyl acrylate, 175 g of 2-ethylhexyl acrylate, and 300 g of acetone/isopropanol (97:3). After nitrogen gas had been passed through the reactor for 45 minutes with stirring, the reactor was heated to 58° C. and 0.2 g of Vazo67® (2,2′-azodi(methylbutyronitrile), from DuPont) was added. The external heating bath was then heated to 75° C., and the reaction was carried out constantly at this external temperature. After a reaction time of 1 hour, a further 0.2 g of Vazo67® (2,2′-azodi(methylbutyronitrile), from DuPont) was added. After 3 hours and 6 hours, dilution took place with 150 g of acetone/isopropanol mixture each time. For the reduction of the residual initiators, after 8 hours and 10 hours, 0.4 g of Perkadox 16® (di(4-tert-butylcyclohexyl)peroxydicarbonate, from Akzo Nobel) was added each time. After a reaction time of 22 hours, the reaction was discontinued and the batch was cooled to room temperature. Subsequently, 20% by weight (based on the polymer) of a styrene resin (FTR 6100 from Mitsui Petrochemical Industries) and 0.75% by weight of Esacure KIP 150™ (from Lamberti) was added, and a solids content of 30% was set using acetone. The solution was clear and transparent.

### Production of the Films of PSA:

Polymers 1-4 were applied from solution to a siliconized PET film 75 μm thick. This was done using a doctor blade. The coatweight was varied via the distance of the doctor blade from the siliconized PET film. The coated specimens were subsequently aired at room temperature for 2 hours. This was followed, at 120° C. with a 10-minute residence time in the forced-air oven, by complete drying and freeing from the residual solvents.

### EXAMPLES

### Example 1

Polymer 1 was coated at 100 g/m² onto the siliconized PET film.

### Example 2

Polymer 1 was coated at 150 g/m² onto the siliconized PET film.

### Example 3

Polymer 2 was coated at 75 g/m² onto the siliconized PET film.

### Example 4

Polymer 2 was coated at 100 g/m² onto the siliconized PET film.

### Example 5

Polymer 3 was coated at 50 g/m² onto the siliconized PET film.

### Example 6

Polymer 3 was coated at 100 g/m² onto the siliconized PET film.

### Example 7

Polymer 4 was coated at 50 g/m² onto the siliconized PET film.

### Example 8

Polymer 4 was coated at 100 g/m² onto the siliconized PET film.

### Results:

First of all, the different examples were subjected to different doses of UV and EBC radiation. UV and electron beams are the most common forms of actinic radiation. The applied radiations are listed in the tables below. Table 1 sets out all of the examples with UV irradiation.

TABLE 1

| Example | UV-C dose in mJ/cm² | UV-B dose in mJ/cm² |
|---|---|---|
| 1 UV | 320 | 1792 |
| 1 UV reference 1 | 800 | 4480 |
| 1 UV reference 2 | 50 | 280 |
| 5 UV | 15 | 100 |
| 5 UV reference 1 | 0 | 70 |
| 5 UV reference 2 | 800 | 4480 |
| 6 UV | 75 | 420 |
| 6 UV reference 1 | 25 | 140 |
| 6 UV reference 2 | 800 | 4480 |
| 7 UV | 25 | 140 |
| 7 UV reference 1 | 0 | 70 |
| 7 UV reference 2 | 800 | 4480 |
| 8 UV | 75 | 420 |
| 8 UV reference 1 | 25 | 140 |
| 8 UV reference 2 | 800 | 4480 |

Table 2 sets out all of the examples with EBC irradiation.

TABLE 2

| Example | Acceleration voltage in kV | Scatter dose kGy |
|---|---|---|
| 1 EB | 60 | 40 |
| 1 EB reference 1 | 180 | 40 |
| 1 EB reference 2 | 180 | 10 |
| 2 EB | 60 | 40 |
| 2 EB reference 1 | 180 | 40 |
| 2 EB reference 2 | 180 | 80 |
| 3 EB | 60 | 60 |
| 3 EB reference 1 | 180 | 20 |
| 3 EB reference 2 | 180 | 60 |
| 4 EB | 60 | 60 |
| 4 EB reference 1 | 180 | 20 |
| 4 EB reference 2 | 180 | 60 |

To examine the optical properties, transmittance and haze measurements were first of all carried out on all specimens. The results are set out in table 3:

TABLE 3

| Example | Transmittance [%] | Haze [%] |
|---|---|---|
| 1 UV | 99.0 | 0.85 |
| 1 UV reference 1 | 99.0 | 0.85 |
| 1 UV reference 2 | 99.0 | 0.85 |
| 5 UV | 98.7 | 1.02 |
| 5 UV reference 1 | 98.6 | 1.13 |
| 5 UV reference 2 | 98.6 | 1.09 |
| 6 UV | 98.5 | 1.25 |
| 6 UV reference 1 | 98.5 | 1.28 |
| 6 UV reference 2 | 98.4 | 1.31 |
| 7 UV | 97.9 | 1.08 |
| 7 UV reference 1 | 97.9 | 1.05 |
| 7 UV reference 2 | 97.5 | 1.14 |
| 8 UV | 97.6 | 1.41 |
| 8 UV reference 1 | 97.7 | 1.38 |
| 8 UV reference 2 | 97.0 | 1.48 |
| 1 EB | 99.0 | 0.85 |
| 1 EB reference 1 | 98.2 | 1.32 |
| 1 EB reference 2 | 98.8 | 1.03 |
| 2 EB | 98.8 | 1.10 |
| 2 EB reference 1 | 98.4 | 1.22 |
| 2 EB reference 2 | 98.7 | 1.16 |
| 3 EB | 97.1 | 1.46 |
| 3 EB reference 1 | 96.8 | 1.48 |
| 3 EB reference 2 | 96.5 | 1.52 |
| 4 EB | 95.7 | 1.64 |
| 4 EB reference 1 | 95.4 | 1.72 |
| 4 EB reference 2 | 95.0 | 1.78 |

The data measured demonstrate that not only the transmittance but also the haze value can meet requirements of optical high transparency. Accordingly, all of the transmittance values are above 90% (corrected/following subtraction of the air reflectance) and also the haze value is below the 5% mark. Even the reference specimens, irradiated more strongly or less strongly, fulfill these requirements.

In order to investigate the technical adhesive properties, the bond strengths were measured for all of the specimens, on both the irradiated side and the remote side. The results are set out in table 4.

TABLE 4

| | Bond strength in [N/cm] | Bond strength in [N/cm] |
|---|---|---|
| Example | radiation side | radiation-remote side |
| 1 UV | 3.0 | 6.8 |
| 1 UV reference 1 | <0.1 | 3.2 |
| 1 UV reference 2 | 6.6 | 6.9 |
| 5 UV | 5.7 | 2.9 |
| 5 UV reference 1 | 2.9 | 2.8 |
| 5 UV reference 2 | <0.1 | 2.1 |
| 6 UV | 8.9 | 5.2 |
| 6 UV reference 1 | 5.0 | 4.7 |
| 6 UV reference 2 | <0.1 | 3.6 |
| 7 UV | 7.2 | 3.3 |
| 7 UV reference 1 | 3.5 | 3.2 |
| 7 UV reference 2 | <0.1 | 3.1 |
| 8 UV | 11.3 | 6.4 |
| 8 UV reference 1 | 5.7 | 6.3 |
| 8 UV reference 2 | <0.1 | 4.0 |
| 1 EB | 4.9 | 8.3 |
| 1 EB reference 1 | 5.4 | 5.0 |
| 1 EB reference 2 | 7.4 | 7.9 |
| 2 EB | 9.2 | 14.3 |
| 2 EB reference 1 | 9.5 | 9.7 |
| 2 EB reference 2 | 8.6 | 8.3 |
| 3 EB | 8.4 | 12.2 |
| 3 EB reference 1 | 11.4 | 11.7 |
| 3 EB reference 2 | 8.2 | 8.5 |
| 4 EB | 9.3 | 13.1 |
| 4 EB reference 1 | 12.5 | 12.9 |
| 4 EB reference 2 | 10.7 | 10.3 |

From table 4 it is apparent that the inventive examples all show a clear differentiation of the bond strengths. In the case of the reference examples, in contrast, there are two different scenarios. Hence there are specimens which are almost homogeneously crosslinked and therefore have hardly different bond strengths, and there are also specimens which on the surface have been crosslinked to such a high extent that there is virtually no longer any bond strength remaining. If, on the other hand, the correct dose range is selected as a function of the PSA coatweight, then it is possible to achieve a differentiation while retaining the optical properties. These specimens can then be employed, for example, for reversible applications. Furthermore, table 4 shows that very different bond strength levels can be achieved.

1. A pressure-sensitive adhesive transfer tape in the form of a backingless adhesive tape having an adhesive layer comprising a pressure-sensitive adhesive based on a poly(meth)acrylate copolymer with the following monomers:
a1) acrylic acid and/or acrylic esters of the following formula:
CH₂═C(R¹)(COOR²),
where R¹ is H or CH₃ and R² is an alkyl chain having 1-30 C atoms,
a2) olefinically unsaturated monomers having functional groups,
where monomers of group a1) are present at not less than 50% by weight, based on the total component (a), and
where monomers of group a2) are present at 0%-30% by weight, based on the total component (a), and b) on a photoinitiator with a fraction of 0%-5% by weight, based on the total polymer mixture, the pressure-sensitive adhesive being crosslinked to different extents on top face and bottom face by actinic radiation, the crosslinking of the pressure-sensitive adhesive being such that both on its top face and on its bottom face it has a PSTC-1 bond strength of at least 1 N/cm, and a bond strength difference between the top-face and bottom-face bond strengths of at least 30%, based on the lower of the two bond strengths.

2. The pressure-sensitive adhesive transfer tape of claim 1, wherein the pressure-sensitive adhesive has an ASTM D 1003 light transmittance of at least 80%, and/or in that the pressure-sensitive adhesive has an ASTM D1003 haze of not more than 5%.

3. The pressure-sensitive adhesive transfer tape of claim 1 wherein the pressure-sensitive adhesive comprises a di- or polyfunctional crosslinker with a fraction of up to 5% by weight, based on the total polymer mixture.

4. (canceled)

5. A method for producing a pressure-sensitive adhesive tape comprising coating a polyacrylate-containing pressure-sensitive adhesive onto a permanent or temporary carrier, the pressure-sensitive adhesive being based on a poly(meth)acrylate copolymer with the following monomers (a):
a1) acrylic acid and/or acrylic esters of the following formula:
CH₂═C(R¹)(COOR²),
where R¹ is H or CH₃ and R² is an alkyl chain having 1-30 C atoms,
a2) olefinically unsaturated monomers having functional groups,
where monomers of group a1) are present at not less than 50% by weight, based on the total component (a), and where monomers of group a2) are present at 0%-30% by weight, based on the total component (a), and b) a photoinitiator with a fraction of 0%-5% by weight, based on the total polymer mixture,
in which the pressure-sensitive adhesive layer is irradiated with UV light and/or electron beams from one side, the dose being selected such that on the side facing the radiation, a high level of crosslinking is achieved, and a lower level of crosslinking or none at all on the remote side, the pressure-sensitive adhesive after crosslinking on top face and bottom face has a PSTC-1 bond strength of at least 1 N/cm, and the pressure-sensitive adhesive after crosslinking has at a bond strength difference between the top-face and bottom-face bond strengths of at least 30% based on the lower of the two bond strengths.

6. The method of claim 5 wherein the pressure-sensitive adhesive is coated with a coatweight in the range of 25-50 g/m² and in that the pressure-sensitive adhesive layer is irradiated with electron beams with an acceleration voltage in the range from 20 to 40 kV and with a scatter dose in the range from 20 to 80 kGy.

7. The method of claim 5, wherein the irradiation is carried out with UV light, more particularly in the wavelength range from 100 to 400 nm, and the irradiation is carried out with a UV dose of more than 250 mJ/cm² and of not more than 500 mJ/cm².

8. The method of claim 5 wherein a pressure-sensitive adhesive free from UV photoinitiators is used and in that the pressure-sensitive adhesive is coated with a coatweight of up to 75 g/m² and in that the pressure-sensitive adhesive layer is irradiated with UV-C with a dose in the range from 250 to 400 J/cm².

9. The method of claim 5 wherein a pressure-sensitive adhesive comprising UV photoinitiators is used and in that the pressure-sensitive adhesive is coated with a coatweight of up to 75 g/m² and in that the pressure-sensitive adhesive layer is irradiated with UV-C with a dose in the range from 0 to 150 J/cm² and with UV-B with a dose in the range from 100 to 400 J/cm².

10. The method of claim 5 wherein the pressure-sensitive adhesive layer is heated during irradiation to a temperature of at least 100° C. and of not more than 170° C.

11. The method according to claim 5 wherein the pressure-sensitive adhesive is coated with a coatweight in the range of 51-100 g/m² and in that the pressure-sensitive adhesive layer is irradiated with electron beams with an acceleration voltage in the range from 40 to 80 kV and a scatter dose in the range from 40 to 100 kGy.

12. The method according to claim 5 wherein the pressure-sensitive adhesive is coated with a coatweight in the range of 101-175 g/m² and in that the pressure-sensitive adhesive layer is irradiated with electron beams with an acceleration voltage in the range from 60 to 100 kV and a scatter dose in the range from 40 to 100 kGy.

13. The method according to claim 5 wherein the pressure-sensitive adhesive is coated with a coatweight in the range of 176-250 g/m² and in that the pressure-sensitive adhesive layer is irradiated with electron beams with an acceleration voltage in the range from 80 to 140 kV and a scatter dose in the range from 40 to 100 kGy.

14. The method according to claim 5 wherein the pressure-sensitive adhesive is coated with a coatweight in the range from 76 to 150 g/m² and in that the pressure-sensitive adhesive layer is irradiated with UV-C with a dose in the range from 300 to 450 J/cm².

15. The method according to claim 5 wherein the pressure-sensitive adhesive is coated with a coatweight in the range from 151 to 250 g/m² and in that the pressure-sensitive adhesive layer is irradiated with UV-C with a dose in the range from 100 to 350 J/cm² and with UV-B with a dose in the range from 1000 to 1500 J/cm².

16. The method according to claim 5 wherein the pressure-sensitive adhesive is coated with a coatweight in the range from 76 to 150 g/m² and in that the pressure-sensitive adhesive layer is irradiated with UV-C with a dose in the range from 0 to 250 J/cm² and with UV-B with a dose in the range from 400 to 1000 J/cm².

17. The method according to claim 5 wherein the pressure-sensitive adhesive is coated with a coatweight in the range from 151 to 250 g/m² and in that the pressure-sensitive adhesive layer is irradiated with UV-C with a dose in the range from 100 to 350 J/cm² and with UV-B with a dose in the range from 1000 to 1500 J/cm².
